(19) United States
(12) Patent Application Publication
(10) Pub. No.: US 2004/0192075 A1
(43) Pub. Date: Sep. 30, 2004

(54) Wireless interconnect device

(76) Inventor: Yi-Hua Lu, Kaohsiung County (TW)

Correspondence Address: HARNESS, DICKEY & PIERCE, P.L.C., P.O. BOX 8910, RESTON, VA, 20195, US

(21) Appl. No.: 10/809,861

(22) Filed: Mar. 26, 2004

(30) Foreign Application Priority Data
Mar. 28, 2003 (TW) 92204930

(51) Int. Cl. H01R 29/00

(52) U.S. Cl. 439/49

(57) ABSTRACT

A wireless interconnect device for using in a computer includes embedded antennae and provides improved signal transmission and reception. The computer includes a casing, an outer lid covering the casing, and a main board located in the casing. The wireless interconnect device includes a connector and a wireless Ethernet card. The connector is a mini PCI-slot connector electrically connecting to the main board. The wireless Ethernet card includes a main body, a first antenna, a second antenna, a first signal line and a second signal line, and an electric connecting part. The electric connecting part electrically connects to the connector. The first and second signal lines respectively electrically connect the first antenna and the second antenna to the main board. The first antenna is located at a front side of the casing and the second antenna is located at a top of the outer lid.

### CROSS-REFERENCE TO RELATED APPLICATIONS

This application claims the benefit of priority of Taiwan R.O.C. Patent Application No. 92204930, file on Mar. 28, 2003, in the Taiwan R.O.C. Intellectual Property Office, the disclosure of which are herein incorporated by reference in their entirety by reference.

### BACKGROUND OF THE INVENTION

1. Field of Invention

The present invention relates to a wireless interconnect device for a computer, and more particularly to a wireless interconnect device by which computers connect to one another for data transmission with improved performance via embedded antennae.

2. Related Art

Ethernet technology is widely used in local-area network (LAN) or in Internet for data transmission between computers. Wire Ethernet has progressed into wireless Ethernet that has no space limit in transmission and thus becomes more convenient to use.

Referring to FIG. 1, which is a perspective view of a commonly used wireless interconnect device, the wireless interconnect device includes a casing 1 having an outer lid 2, a main board 3 located inside the casing 1 and having a card connector 31, and a wireless Ethernet card 4 connecting to the card connector 31. The card connector 31 is a PCI connector. The wireless Ethernet card 4 is further provided with a positioning sheet 41 to position the wireless Ethernet card 4 in place. An antenna is further formed at a rear side of the positioning sheet 41 to expose through a rear side of the casing 1 to transmit and receive signals or data.

However, such an antenna 42 is a short dipole and its position at the rear side of the casing 1 causes several disadvantages, such as antenna breakage and poor signal reception. An embedded antenna has been proposed to prevent antenna breakage, but like this, signal reception gets worse.

Therefore, there is a need of a wireless interconnect device that overcomes the above problems.

### SUMMARY OF THE INVENTION

Therefore, the present invention provides a wireless interconnect device, in which an antenna is embedded to prevent any damage, and the signal transmission and reception are improved.

In order to achieve the above and other objectives, the wireless interconnect device of the invention suitable for use in a computer includes a connector and a wireless Ethernet card. The computer includes a casing, an outer lid covering the casing, and a main board located in the casing. The connector can be a mini PCI-slot or a mini USB connector that electrically connects to the main board. The wireless Ethernet card includes a main body, a first antenna, a second antenna, a first signal line, a second signal line, and an electric connecting part (or a coupling part). The electric connecting part (or the coupling part) electrically connects to the connector. The first and second signal lines respectively electrically connect the first antenna and the second antenna to the main board. The first antenna is located at the front side of the casing and the second antenna is located at the top of the outer lid.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below illustration only, and thus doesn't limit the present invention, wherein:

FIG. 1 is a perspective view of a conventional wireless interconnect device;

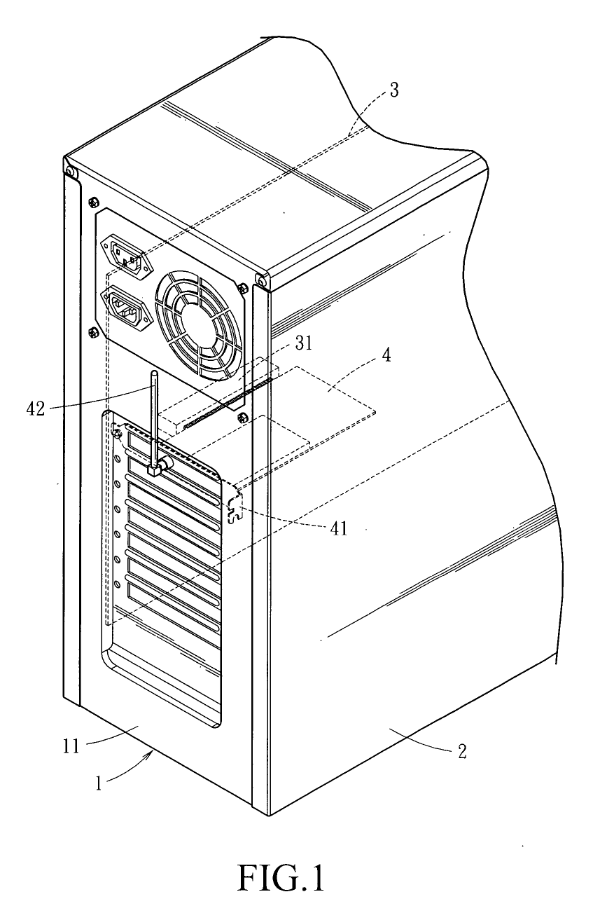

FIG. 2 is an exploded view of a wireless interconnect device according to one embodiment of the invention;

FIG. 3 is a partially enlarged view of part A of FIG. 2;

FIG. 4 is a perspective view of a wireless Ethernet card of FIG. 2;

FIG. 5 is a perspective view of an assembled wireless interconnect device of FIG. 2;

FIG. 6 is a cross-sectional view of a part of a wireless interconnect device according to one embodiment of the invention; and

FIG. 7 is a partially enlarged view of a wireless interconnect device according to another embodiment of the invention.

### DETAILED DESCRIPTION OF THE INVENTION

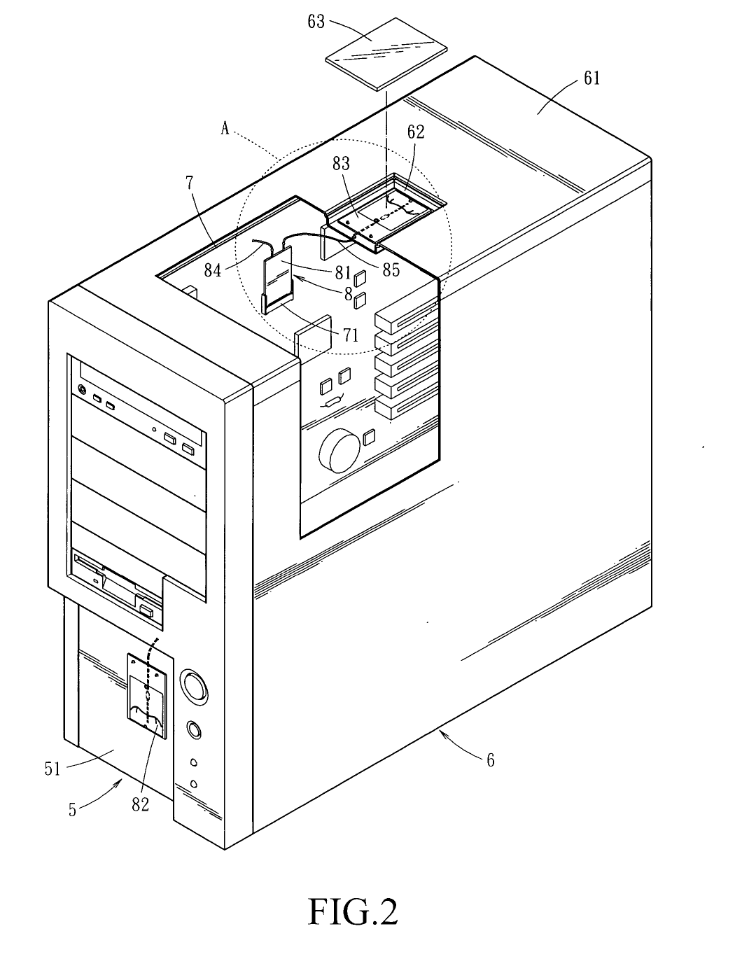

Referring to FIG. 2 through FIG. 7, the wireless interconnect device of the invention includes a metallic casing 5, an outer lid 6 covering the casing 5 and a main board 7 located inside the casing 5. The wireless interconnect device includes a connector 71 connecting to the main board 7, and a wireless Ethernet card 8 having at least one antenna.

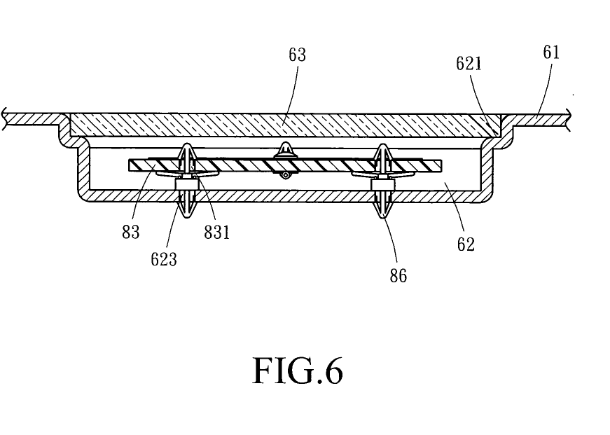

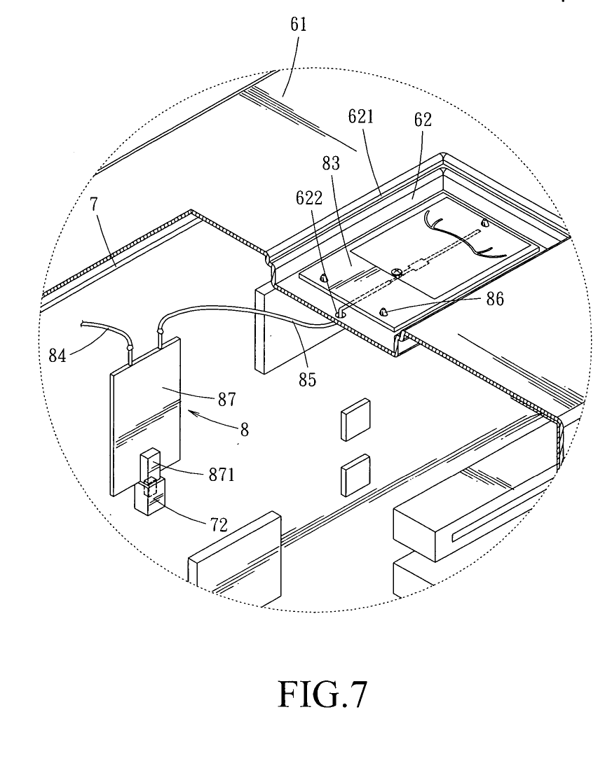

The connector 7 can be a mini PCI-slot connector 71 or a mini USB connector 72 (as shown in FIG. 7) that electrically connects to the above main board. The outer lid 6 can be formed integrally, or one as shown in FIG. 2 including a plastic front lid (not shown), a metallic upper lid 61, and a pair of side lids (not shown). At the top of the outer lid 6 or the upper lid 61 is formed an accommodating space 62 with a slot 622 and a plurality of fixing holes 623 (as shown in FIG. 6). There is a positioning groove 621 formed along the interior of the accommodating space 62 to position a cover 63.

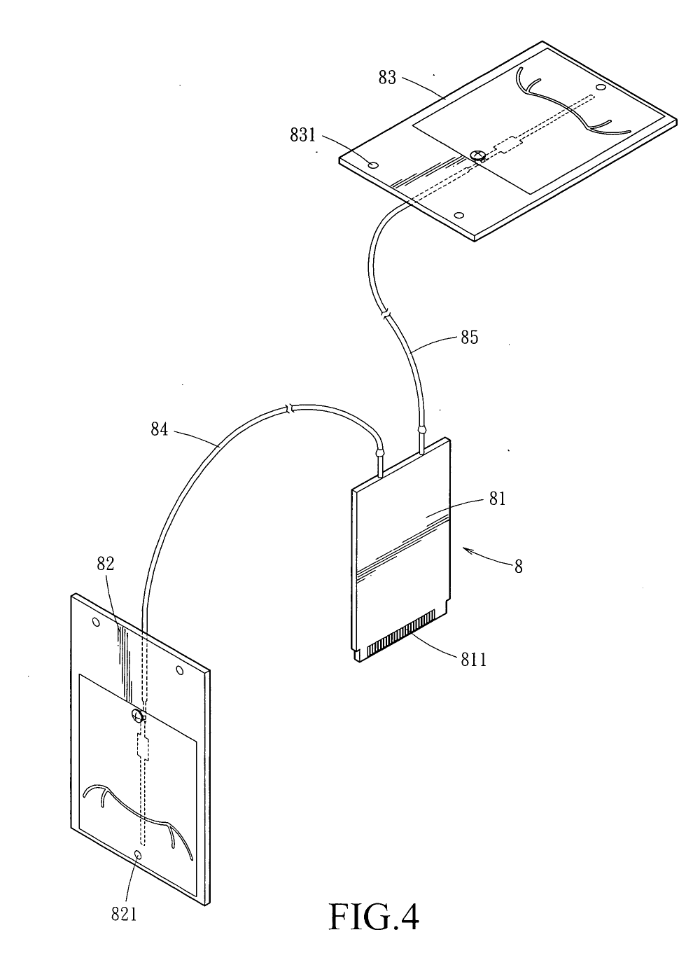

Referring to FIG. 4, the wireless Ethernet card 8 includes a main body 81, a first antenna 82, a second antenna 83, a first signal line 84 and a second signal line 85. The main body 81 is further provided with an electric connecting part 811 and connects to the first ends of all signal lines 84, 85. The first and second antenna 82, 83 connect to the second ends of the signal lines 84, 85. Referring to FIG. 4 and FIG. 6, the antenna 82, 83 are respectively with a plurality of through holes 821, 831 through which the antennae can be properly positioned via positioning elements.

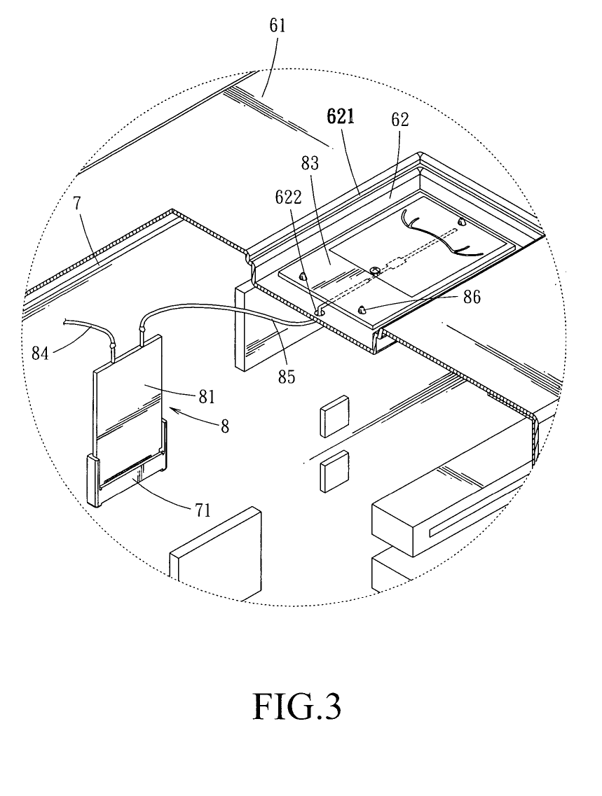

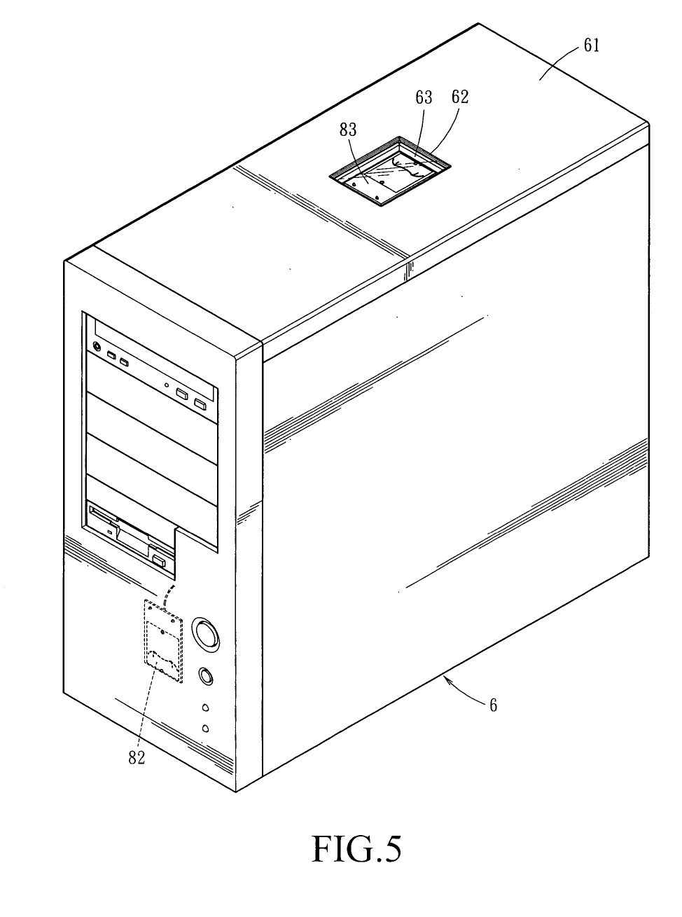

Referring to FIG. 3, the main body 81 of the wireless Ethernet card 8 inserts into the connector 71 so that the connecting part 811 electrically connects to the connector 71. Referring to FIG. 5, the first antenna 82 is located at the front side 51 of the casing 5. Referring to FIG. 2, FIG. 3 and FIG. 6, the second antenna 83 is located inside the accommodating space 62. As shown in FIG. 6, a positioning device 86 penetrates through one through hole 831 of the antenna 83 and abuts against one fixing hole 623 so that the second antenna 83 is positioned in place. Similarly, the first antenna 82 is positioned at the front side 51. Referring to FIG. 3, the second signal line 85 penetrates through the slot 622. The cover 63 covers the top of the accommodating space 62 via adhesive or in a snapping manner in order to avoid dust.

Referring to FIG. 7, the connector 72 on the main board 7 is a mini USB connector electrically connecting to the main board 7. A main body 87 of the wireless Ethernet card 8 has a coupling part to electrically connect to the connector 72.

With the use of the Ethernet car 8 having the connecting part 811 or the connector 871, the wireless interconnect device of the invention is compatible with the mini PCI connector 71 or mini USB connector 72 connecting to the main board 7. The first and second antennae 82, 83 respectively, from the interior of the casing 5, connect to the front side 51 and the accommodating space 62 covered by the upper lid 61. Thereby, these antennae are embedded inside the casing, while the position of the first and second antennae 82, 83 provide good and wide-angle signal transmission and reception. This is particularly suitable for use in the host, usually located on the ground. In the invention, the antennae are not exposed or protruded from the casing, reducing inconvenience. The antennae are fixed to the host with resistance compliant, with various antenna providers to achieve optimal signal transmission and reception and lowered production cost. The cover 63 can be made of transparent material for aesthetic purpose.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A wireless interconnect device for a computer, the computer comprising a casing, an outer lid covering the casing, and a main board located in the casing, comprising:
a connector, which is a mini PCI-slot connector electrically connecting to the main board; and
a wireless Ethernet card, including a main body, a first antenna, a second antenna, a first signal line and a second signal line, and an electric connecting part, the electric connecting part electrically connecting to the mini PCI-slot connector, the first and second signal lines respectively electrically connecting the first antenna and the second antenna to the main board, the first antenna being located at a front side of the casing and the second antenna being located at a top of the outer lid.

2. The wireless interconnect device of claim 1, wherein the top of the outer lid further has an accommodating space in which the second antenna is located.

3. The wireless interconnect device of claim 2, wherein the accommodating space further has a cover.

4. The wireless interconnect device of claim 1, wherein the top of the out lid further has a plurality of first fixing holes and a first slot, the front of the casing further has a plurality of second fixing holes and a second slot, the first and second antennas respectively having third and fourth fixing holes corresponding to the second and first fixing holes, the first and fourth fixing holes connecting to one another via first positioning elements and the second and third fixing holes connecting to one another via second positioning elements so that the first and second signal lines respectively penetrate through these slots.

5. A wireless interconnect device for a computer, the computer comprising a casing, an outer lid covering the casing, and a main board located in the casing, comprising:
a connector, which is a mini USB connector electrically connecting to the main board; and
a wireless Ethernet card, including a main body, a first antenna, a second antenna, a first signal line and a second signal line, and a coupling part, the coupling part electrically connecting to the mini USB connector, the first and second signal lines respectively electrically connecting the first antenna and the second antenna to the main board, the first antenna being located at a front side of the casing and the second antenna being located at a top of the outer lid.

6. The wireless interconnect device of claim 5, wherein the top of the outer lid further has an accommodating space in which the second antenna is located.

7. The wireless interconnect device of claim 6, wherein the accommodating space further has a cover.

8. The wireless interconnect device of claim 5, wherein the top of the out lid further has a plurality of first fixing holes and a first slot, the front of the casing further has a plurality of second fixing holes and a second slot, the first and second antennas respectively having third and fourth fixing holes corresponding to the second and first fixing holes, the first and fourth fixing holes connecting to one another via first positioning elements and the second and third fixing holes connecting to one another via second positioning elements so that the first and second signal lines respectively penetrate through these slots.
